(19) United States
(12) Patent Application Publication
(10) Pub. No.: US 2023/0112530 A1
(43) Pub. Date: Apr. 13, 2023

(54) GAS SENSOR ELEMENT

(71) Applicant: NGK Insulators, Ltd., Nagoya-shi (JP)

(72) Inventors: Yusuke WATANABE, Nagoya-shi (JP); Shotaro NIIZUMA, Nagoya-shi (JP); Kirari TAKAHASHI, Nagoya-shi (JP); Toshihiro HIRAKAWA, Nagoya-shi (JP)

(21) Appl. No.: 17/882,910

(22) Filed: Aug. 8, 2022

(30) Foreign Application Priority Data
Sep. 30, 2021 (JP) 2021-161439

(51) Int. Cl. G01N 27/41; G01N 27/406; G01N 27/407

(52) U.S. Cl. CPC G01N 27/41; G01N 27/4062; G01N 27/4071

(57) ABSTRACT

In order to suppress a deterioration in the measurement precision while also reducing the manufacturing cost of a gas sensor element, an aspect of the present invention is directed to a gas sensor element including: a stack formed by stacking a plurality of oxygen ion-conductive solid electrolyte layers, and including an internal space configured to receive a measurement target gas from the outside, a first face adjacent to the internal space, and a second face adjacent to an external space; a first pump electrode provided on the first face; a second pump electrode provided on the second face; a first lead formed on the first face so as to extend from the first pump electrode; and a second lead formed on the second face so as to extend from the second pump electrode and configured to be electrically connected to the first lead. At least one of the first and second leads has a shape with a maximum current density of 3.5 A/mm² or less.

### CROSS-REFERENCE TO RELATED APPLICATION

The present application claims priority from Japanese application JP 2021-161439, filed on Sep. 30, 2021, the contents of which is hereby incorporated by reference into this application.

### TECHNICAL FIELD

The present invention relates to a gas sensor element.

### BACKGROUND ART

There are gas sensor elements constituted by a plurality of oxygen ion-conductive solid electrolyte layers (JP 2021-032787A, for example). Generally, this sort of gas sensor element is provided with an internal space into which a measurement target gas is introduced, and is further provided with a pair of pump electrodes that respectively face the internal space and the external space. Oxygen can be pumped out into the external space by applying a voltage to this pair of pump electrodes, and the concentration of oxygen or oxides (e.g., nitrogen oxides) can be measured by measuring the pump current that flows during this process.

JP 2021-032787A is an example of related art.

### SUMMARY OF THE INVENTION

The inventors of the present invention found that conventional gas sensor elements have the following issues. That is to say, a gas sensor element has leads that are electrically connected to pump electrodes. Precious metals such as platinum are used as materials for the leads. Therefore, the larger the cross-sectional area of the leads, the higher the manufacturing cost of the gas sensor element. Thus, in order to reduce manufacturing costs, it is conceivable to reduce the cross-sectional area of the leads. However, if the cross-sectional area of the leads is reduced, the resistance of the leads increases, which may result in a deterioration in the measurement precision.

As an example, the gas sensor element disclosed in JP 2021-032787A is used to explain one cause of a deterioration in the measurement precision. The gas sensor element disclosed in JP 2021-032787A includes a main pump cell, an auxiliary pump cell, and a measurement pump cell. The main pump cell is constituted by an internal pump electrode facing a first internal cavity, an external pump electrode in contact with an external space, and a solid electrolyte layer held between these electrodes. The auxiliary pump cell is constituted by an auxiliary pump electrode facing a second internal cavity, an external pump electrode, and a solid electrolyte layer held between these electrodes. The measurement pump cell is constituted by a measurement electrode facing the second internal cavity, an external pump electrode, and a solid electrolyte layer held between these electrodes. In this gas sensor element, the concentration of oxygen contained in the measurement target gas is adjusted by the main pump cell and the auxiliary pump cell, and the concentration of nitrogen oxide contained in the measurement target gas is measured by the measurement pump cell.

In this gas sensor element, it is assumed that the cross-sectional area of leads connected to electrodes constituting the main pump cell is reduced to lower the manufacturing cost. In this case, the resistance of the electrodes of the main pump cell and the leads increases due to the smaller cross-sectional area of the leads, which results in an increase in the voltage applied to the main pump cell. When the voltage applied to the main pump cell increases, nitrogen oxide is more likely to decompose in the range of the main pump cell. In particular, the higher the concentration of oxygen in the measurement target gas, the more likely the nitrogen oxide is to decompose, and, as a result, the dependency of the NO_{X} current (current flowing in the measurement pump cell) on the concentration of oxygen in the measurement target gas deteriorates. In other words, the linearity of the NO_{X} current with respect to the concentration of oxygen in the measurement target gas is impaired. This complicates the calibration of the relationship between the concentration of oxygen in the measurement target gas and the NO_{X} current, and may result in a deterioration in the precision of measuring the concentration of nitrogen oxide.

This issue is not limited to cases in which the cross-sectional area of the leads connected to the electrodes of the main pump cell is reduced, but may also occur when the cross-sectional area of leads connected to electrodes of other pump cells is reduced. This issue may also occur not only in gas sensor elements configured to measure the concentration of nitrogen oxide, but also in other gas sensor elements such as those configured to measure the concentration of oxygen, for example.

In one aspect, the present invention was made in view of these circumstances, and it is an object thereof to provide a technique for suppressing a deterioration in the measurement precision while also reducing the manufacturing cost of a gas sensor element.

In order to solve the above-mentioned issues, the present invention adopts the following configuration.

An aspect of the present invention is directed to a gas sensor element including: a stack formed by stacking a plurality of oxygen ion-conductive solid electrolyte layers, and including an internal space configured to receive a measurement target gas from the outside, a first face adjacent to the internal space, and a second face adjacent to an external space; a first pump electrode provided on the first face; a second pump electrode provided on the second face; a first lead formed on the first face so as to extend from the first pump electrode; and a second lead formed on the second face so as to extend from the second pump electrode and configured to be electrically connected to the first lead. At least one of the first and second leads has a shape with a maximum current density of 3.5 A/mm² or less.

In the gas sensor element according to this configuration, at least one of the first and second leads is set to have a maximum current density of 3.5 A/mm² or less. The current density is determined by the relational expression “current density = current / cross-sectional area (electrode area)”. According to this relational expression, a larger cross-sectional area results in a smaller (maximum) current density, and a smaller cross-sectional area results in a larger (maximum) current density. As described above, it is possible to reduce the manufacturing cost of the gas sensor by reducing the cross-sectional area of the leads (which increases the maximum current density), but this configuration may possibly cause a deterioration in the measurement precision. On the other hand, the inventors of the present invention performed the examples described below, and found that, if the maximum current density is 3.5 A/mm² or less, it is possible to suppress a deterioration in the measurement precision. Thus, with this configuration, it is possible to suppress a deterioration in the measurement precision while also reducing the manufacturing cost, by reducing the cross-sectional area of the leads based on the maximum current density (i.e., such that the maximum current density is 3.5 A/mm² or less) .

From the viewpoint of suppressing a deterioration in the measurement precision, at least one of the first and second leads may have a maximum current density that is set to 3.4, 3.3, 3.2, 3.1, 3.0, 2.9, 2.8, 2.7, 2.6, 2.5, 2.4, 2.3, 2.2, 2.1, 2.0, 1.9, 1.8, 1.7, 1.6, 1.5, 1.4, 1.3, 1.2, 1.1, or 1.0 A/mm² or less. It is possible to reduce the manufacturing cost and also to suppress a deterioration in the measurement precision by increasing the cross-sectional area of the leads such that the maximum current density is close to these reference values.

In the gas sensor element according to the above-described aspect, it is also possible that the at least one of the first and second leads is a lead with a higher resistance out of the first and second leads. As described above, a higher resistance makes a measurement target gas more likely to decompose before reaching the measurement cell, which may result in a deterioration in the measurement precision. With this configuration, it is possible to appropriately suppress a deterioration in the measurement precision while also reducing the manufacturing cost, by setting the maximum current density of the lead with a higher resistance to 3.5 A/mm² or less.

In the gas sensor element according to the above-described aspect, it is also possible that at least one of the first and second leads includes: a plurality of columns each extending in a first direction; and a plurality of connecting portions each extending in a second direction that intersects the first direction and each being connected to two adjacent columns out of the plurality of columns, and a gap is provided between two connecting portions that are adjacent to each other in the first direction out of the plurality of connecting portions. With this configuration, compared with the case of a solid structure, the amount of material used for the leads can be suppressed by the size of gaps provided, and thus it is possible to reduce the manufacturing cost of the gas sensor.

In the gas sensor element according to the above-described aspect, it is also possible that each of the connecting portions has two end portions that are respectively connected to two adjacent columns, and a center portion that is at a distance from the two end portions, and at least one of the two end portions of the connecting portion has a width larger than that of the center portion. When current flows, stress is likely to occur at the end portions of the connecting portions. This stress tends to cause damage (e.g., a breakage) at the end portions of the connecting portions. With this configuration, the end portions have a width larger than that of the center portion, and thus a breakage at the end portions can be suppressed, and, as a result, it is possible to improve the durability of the leads.

According to the present invention, it is possible to suppress a deterioration in the measurement precision while also reducing the manufacturing cost of a gas sensor element.

### BRIEF DESCRIPTION OF THE DRAWINGS

FIG. 1 is a cross-sectional schematic view schematically showing an example of the configuration of a sensor element according to an embodiment.

FIG. 2A is a schematic view schematically showing an example of a lead according to the embodiment.

FIG. 2B is a schematic view schematically showing an example of the lead according to the embodiment.

FIG. 3 is a schematic view schematically showing an example of the lead according to a modified example.

FIG. 4 is an enlarged schematic view schematically showing an example of the lead according to a modified example.

FIG. 5 is a schematic view schematically showing an example of the lead according to a modified example.

FIG. 6 is a schematic view schematically showing an example of the lead according to a modified example.

FIG. 7 is a schematic view schematically showing an example of the lead according to a modified example.

### EMBODIMENTS OF THE INVENTION

Hereinafter, an embodiment according to an aspect of the present invention (also referred to as “the embodiment” hereinafter) will be described with reference to the drawings. Note that the embodiment, which will be described below, is merely an example of the invention in all respects. It will be appreciated that various improvements or modifications can be made without departing from the scope of the invention. In implementing the invention, specific configurations according to the embodiment may be adopted as appropriate.

A gas sensor element according to this embodiment includes a stack, a first pump electrode, a second pump electrode, a first lead, and a second lead. The stack is formed by stacking a plurality of oxygen ion-conductive solid electrolyte layers, and includes an internal space configured to receive a measurement target gas from the outside, a first face adjacent to the internal space, and a second face adjacent to an external space. The state of being “adjacent” may be a state of being directly adjacent to a space or a state of being indirectly adjacent to a space via a coating or the like. The first pump electrode is provided on the first face, and the second pump electrode is provided on the second face. The first lead is formed on the first face so as to extend from the first pump electrode. The second lead is formed on the second face so as to extend from the second pump electrode and is configured to be electrically connected to the first lead. At least one of the first and second leads has a shape with a maximum current density of 3.5 A/mm² or less. Hereinafter, an example of the gas sensor element having this configuration will be described.

### Configuration Example

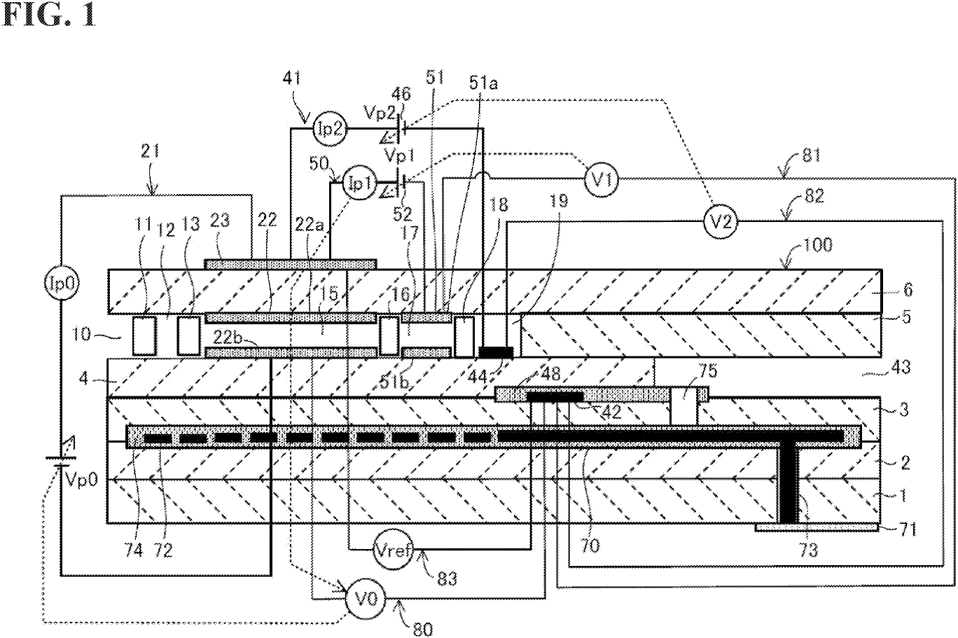

FIG. 1 is a cross-sectional schematic view schematically showing an example of the configuration of a gas sensor element 100 according to this embodiment. The gas sensor element 100 includes a stack formed by stacking a first substrate layer 1, a second substrate layer 2, a third substrate layer 3, a first solid electrolyte layer 4, a spacer layer 5, and a second solid electrolyte layer 6 sequentially from the lower side in the cross-sectional view in FIG. 1. The layers 1 to 6 are constituted by oxygen ion-conductive solid electrolyte layers made of zirconia (ZrO₂) or the like. The solid electrolyte forming the layers 1 to 6 may be a dense material. The dense material is a material with a porosity of 5% or less.

In this embodiment, an internal space configured to receive a measurement target gas from an external space is provided between a lower face 62 of the second solid electrolyte layer 6 and an upper face of the first solid electrolyte layer 4, at a front end of the gas sensor element 100. The internal space according to this embodiment is configured such that a gas introduction opening 10, a first diffusion control unit 11, a buffer space 12, a second diffusion control unit 13, a first internal cavity 15, a third diffusion control unit 16, a second internal cavity 17, a fourth diffusion control unit 18, and a third internal cavity 19 are arranged in this order adjacent to each other in a connected manner. In other words, the internal space according to this embodiment has a three-cavity structure (the first internal cavity 15, the second internal cavity 17, and the third internal cavity 19).

In an example, this internal space is formed by cutting out the spacer layer 5. The upper portion of the internal space is defined by the lower face 62 of the second solid electrolyte layer 6. The lower portion of the internal space is defined by the upper face of the first solid electrolyte layer 4. The side portions of the internal space are defined by the side faces of the spacer layer 5.

The first diffusion control unit 11 is provided as two laterally long slits (whose openings have the longitudinal direction that is along the direction perpendicular to the section of the diagram). The second diffusion control unit 13 and the third diffusion control unit 16 are provided as holes whose length extending in the direction perpendicular to the section of the diagram is shorter than that of the internal cavities (15, 17, and 19). The fourth diffusion control unit 18 is provided as a hole that is open only on the upper side in the direction perpendicular to the section of the diagram. The region (internal space) from the gas introduction opening 10 to the third internal cavity 19 may be referred to as a gas flow passage.

Furthermore, a reference gas introduction space 43 having side portions defined by the side faces of the first solid electrolyte layer 4 is provided between the upper face of the third substrate layer 3 and the lower face of the spacer layer 5, at a position that is farther from the front side than the gas flow passage is. For example, reference gas such as air is introduced into the reference gas introduction space 43.

An air introduction layer 48 is provided at part of the upper face of the third substrate layer 3 adjacent to the reference gas introduction space 43. The air introduction layer 48 is made of porous alumina, and is configured to receive reference gas introduced via the reference gas introduction space 43. Furthermore, the air introduction layer 48 is formed so as to cover a reference electrode 42.

The reference electrode 42 is held between the upper face of the third substrate layer 3 and the first solid electrolyte layer 4, and is covered by the air introduction layer 48 that is connected to the reference gas introduction space 43. The reference electrode 42 is used to measure the oxygen concentration (oxygen partial pressure) in the first internal cavity 15 and the second internal cavity 17. This configuration will be described later in detail.

The gas introduction opening 10 is a region that is open to the external space, in the gas flow passage. The gas sensor element 100 is configured to introduce a measurement target gas from the external space via the gas introduction opening 10 into the gas sensor element.

The first diffusion control unit 11 is a region that applies a predetermined diffusion resistance to the measurement target gas introduced from the gas introduction opening 10.

The buffer space 12 is a space that is provided in order to guide the measurement target gas introduced from the first diffusion control unit 11 to the second diffusion control unit 13.

The second diffusion control unit 13 is a region that applies a predetermined diffusion resistance to the measurement target gas introduced from the buffer space 12 into the first internal cavity 15.

When the measurement target gas is introduced from the external space of the gas sensor element 100 into the first internal cavity 15, the measurement target gas may be abruptly introduced from the gas introduction opening 10 into the gas sensor element 100 due to a change in the pressure of the measurement target gas in the external space (a pulsation of the exhaust pressure in the case in which the measurement target gas is exhaust gas of an automobile). In this case as well, according to this configuration, the introduced measurement target gas is not directly introduced into the first internal cavity 15, but is introduced into the first internal cavity 15 after passing through the first diffusion control unit 11, the buffer space 12, and the second diffusion control unit 13 where a change in the concentration of the measurement target gas is canceled. Accordingly, a change in the concentration of the measurement target gas introduced into the first internal cavity 15 is reduced to be almost negligible.

The first internal cavity 15 is provided as a space for adjusting the oxygen partial pressure in the measurement target gas introduced via the second diffusion control unit 13. The oxygen partial pressure is adjusted through an operation of a main pump cell 21.

The main pump cell 21 is an electro-chemical pump cell constituted by an internal pump electrode 22, an external pump electrode 23, and the second solid electrolyte layer 6 held between these electrodes. The internal pump electrode 22 has a ceiling electrode portion 22a provided over substantially the entire lower face 62 of the second solid electrolyte layer 6 that is adjacent to (faces) the first internal cavity 15. The external pump electrode 23 is provided so as to be adjacent to the external space, in the region corresponding to the ceiling electrode portion 22a, on an upper face 63 of the second solid electrolyte layer 6.

The internal pump electrode 22 is formed across upper and lower solid electrolyte layers (the second solid electrolyte layer 6 and the first solid electrolyte layer 4) that define the first internal cavity 15, and the spacer layer 5 that forms side walls. Specifically, the ceiling electrode portion 22a is formed on the lower face 62 of the second solid electrolyte layer 6 that forms the ceiling face of the first internal cavity 15, and a bottom electrode portion 22b is formed on the upper face of the first solid electrolyte layer 4 that forms the bottom face. Side electrode portions (not shown) that connect the ceiling electrode portion 22a and the bottom electrode portion 22b are formed on side wall faces (internal faces) of the spacer layer 5 that form two side wall portions of the first internal cavity 15. That is to say, the internal pump electrode 22 is arranged in the form of a tunnel at the region in which the side electrode portions are arranged.

The internal pump electrode 22 and the external pump electrode 23 are formed as porous cermet electrodes (e.g., cermet electrodes made of Pt and ZrO₂ containing 1% of Au). Note that the internal pump electrode 22 with which the measurement target gas is brought into contact is made of a material that has a lowered capability of reducing a nitrogen oxide (NOₓ) component in the measurement target gas.

The gas sensor element 100 is configured such that the main pump cell 21 can apply a desired pump voltage Vp0 to a point between the internal pump electrode 22 and the external pump electrode 23, thereby causing a pump current Ip0 to flow in the positive direction or the negative direction between the internal pump electrode 22 and the external pump electrode 23, so that oxygen in the first internal cavity 15 is pumped out to the external space or oxygen in the external space is pumped into the first internal cavity 15.

Furthermore, in order to detect the oxygen concentration (oxygen partial pressure) in the atmosphere in the first internal cavity 15, the internal pump electrode 22, the second solid electrolyte layer 6, the spacer layer 5, the first solid electrolyte layer 4, the third substrate layer 3, and the reference electrode 42 constitute a main pump-controlling oxygen partial pressure detection sensor cell 80 (i.e., an electro-chemical sensor cell).

The gas sensor element 100 is configured to be capable of specifying the oxygen concentration (oxygen partial pressure) in the first internal cavity 15 by measuring an electromotive force V0 in the main pump-controlling oxygen partial pressure detection sensor cell 80. Moreover, the pump current Ip0 is controlled by performing feedback control on Vp0 such that the electromotive force V0 is kept constant. Accordingly, the concentration of oxygen in the first internal cavity 15 can be kept at a predetermined constant value.

The third diffusion control unit 16 is a region that applies a predetermined diffusion resistance to the measurement target gas whose oxygen concentration (oxygen partial pressure) has been controlled through an operation of the main pump cell 21 in the first internal cavity 15, thereby guiding the measurement target gas to the second internal cavity 17.

The second internal cavity 17 is provided as a space for further adjusting the oxygen partial pressure in the measurement target gas introduced via the third diffusion control unit 16. This oxygen partial pressure is adjusted through an operation of an auxiliary pump cell 50.

The auxiliary pump cell 50 is an auxiliary electro-chemical pump cell constituted by an auxiliary pump electrode 51, the external pump electrode 23 (which is not limited to the external pump electrode 23, and may be any appropriate electrode outside the gas sensor element 100), and the second solid electrolyte layer 6. The auxiliary pump electrode 51 has a ceiling electrode portion 51a provided on substantially the entire lower face of the second solid electrolyte layer 6 that faces the second internal cavity 17.

The auxiliary pump electrode 51 with this configuration is arranged inside the second internal cavity 17 in the form of a tunnel as with the above-described internal pump electrode 22 arranged inside the first internal cavity 15. That is to say, the ceiling electrode portion 51a is formed on the lower face 62 of the second solid electrolyte layer 6 that forms the ceiling face of the second internal cavity 17, and a bottom electrode portion 51b is formed on the upper face of the first solid electrolyte layer 4 that forms the bottom face of the second internal cavity 17. Side electrode portions (not shown) that connect the ceiling electrode portion 51a and the bottom electrode portion 51b are respectively formed on two wall faces of the spacer layer 5 that form side walls of the second internal cavity 17. Accordingly, the auxiliary pump electrode 51 has a structure in the form of a tunnel.

Note that the auxiliary pump electrode 51 is also made of a material that has a lowered capability of reducing a nitrogen oxide component in the measurement target gas, as with the internal pump electrode 22.

The gas sensor element 100 is configured such that the auxiliary pump cell 50 can apply a desired voltage Vp1 to a point between the auxiliary pump electrode 51 and the external pump electrode 23, so that oxygen in the atmosphere in the second internal cavity 17 is pumped out to the external space or oxygen in the external space is pumped into the second internal cavity 17.

Furthermore, in order to control the oxygen partial pressure in the atmosphere in the second internal cavity 17, the auxiliary pump electrode 51, the reference electrode 42, the second solid electrolyte layer 6, the spacer layer 5, the first solid electrolyte layer 4, and the third substrate layer 3 constitute an auxiliary pump-controlling oxygen partial pressure detection sensor cell 81 (i.e., an electro-chemical sensor cell).

Note that the auxiliary pump cell 50 performs pumping using a variable power source 52 whose voltage is controlled based on an electromotive force V1 detected by the auxiliary pump-controlling oxygen partial pressure detection sensor cell 81. Accordingly, the oxygen partial pressure in the atmosphere in the second internal cavity 17 is controlled to be a partial pressure that is low enough to not substantially affect the NO_{X} measurement.

Furthermore, a pump current Ip1 is also used to control the electromotive force of the main pump-controlling oxygen partial pressure detection sensor cell 80. Specifically, the pump current Ip1 is input as a control signal to the main pump-controlling oxygen partial pressure detection sensor cell 80, and the electromotive force V0 is controlled such that a gradient of the oxygen partial pressure in the measurement target gas that is introduced from the third diffusion control unit 16 into the second internal cavity 17 is always kept constant. When the sensor is used as an NOₓ sensor, the concentration of oxygen in the second internal cavity 17 is kept at a constant value that is about 0.001 ppm through an operation of the main pump cell 21 and the auxiliary pump cell 50.

The fourth diffusion control unit 18 is a region that applies a predetermined diffusion resistance to the measurement target gas whose oxygen concentration (oxygen partial pressure) has been controlled through an operation of the auxiliary pump cell 50 in the second internal cavity 17, thereby guiding the measurement target gas to the third internal cavity 19.

The third internal cavity 19 is provided as a space for performing processing regarding measurement of the concentration of nitrogen oxide (NO_{X}) in the measurement target gas introduced via the fourth diffusion control unit 18. The NOₓ concentration is measured through an operation of a measurement pump cell 41. In this embodiment, the measurement target gas subjected to adjustment of the oxygen concentration (oxygen partial pressure) in advance in the first internal cavity 15 and then introduced via the third diffusion control unit is further subjected to adjustment of the oxygen partial pressure by the auxiliary pump cell 50 in the second internal cavity 17. Accordingly, the concentration of oxygen in the measurement target gas introduced from the second internal cavity 17 into the third internal cavity 19 can be precisely kept constant. Thus, the gas sensor element 100 according to this embodiment can measure the NO_{X} concentration with a high level of precision.

The measurement pump cell 41 measures the concentration of nitrogen oxide in the measurement target gas, in the third internal cavity 19. The measurement pump cell 41 is an electro-chemical pump cell constituted by a measurement electrode 44, the external pump electrode 23, the second solid electrolyte layer 6, the spacer layer 5, and the first solid electrolyte layer 4. In the example in FIG. 1, the measurement electrode 44 is provided on the upper face of the first solid electrolyte layer 4 that is adjacent to (faces) the third internal cavity 19.

The measurement electrode 44 is a porous cermet electrode. The measurement electrode 44 functions also as an NOₓ reduction catalyst for reducing NO_{X} that is present in the atmosphere in the third internal cavity 19. In the example in FIG. 1, the measurement electrode 44 is exposed in the third internal cavity 19. In another example, the measurement electrode 44 may be covered by a diffusion control unit. The diffusion control unit may be constituted by a porous membrane mainly made of alumina (Al₂O₃) . The diffusion control unit serves to limit the amount of NOₓ flowing into the measurement electrode 44, and also functions as a protective membrane of the measurement electrode 44.

The gas sensor element 100 is configured such that the measurement pump cell 41 can pump out oxygen generated through decomposition of nitrogen oxide in the atmosphere around the measurement electrode 44, and detect the generated amount as a pump current Ip2.

Furthermore, in order to detect the oxygen partial pressure around the measurement electrode 44, the second solid electrolyte layer 6, the spacer layer 5, the first solid electrolyte layer 4, the third substrate layer 3, the measurement electrode 44, and the reference electrode 42 constitute a measurement pump-controlling oxygen partial pressure detection sensor cell 82 (i.e., an electro-chemical sensor cell). A variable power source 46 is controlled based on a voltage (an electromotive force) V2 detected by the measurement pump-controlling oxygen partial pressure detection sensor cell 82.

The measurement target gas guided into the third internal cavity 19 reaches the measurement electrode 44 in a state in which the oxygen partial pressure is controlled. Nitrogen oxide in the measurement target gas around the measurement electrode 44 is reduced to generate oxygen (2NO → N₂ + O₂). The generated oxygen is pumped by the measurement pump cell 41, and, at that time, a voltage Vp2 of the variable power source is controlled such that a control voltage V2 detected by the measurement pump-controlling oxygen partial pressure detection sensor cell 82 is kept constant. The amount of oxygen generated around the measurement electrode 44 is proportional to the concentration of nitrogen oxide in the measurement target gas, and thus it is possible to calculate the concentration of nitrogen oxide in the measurement target gas, using the pump current Ip2 at the measurement pump cell 41.

Furthermore, if the measurement electrode 44, the first solid electrolyte layer 4, the third substrate layer 3, and the reference electrode 42 are combined to constitute an oxygen partial pressure detection means as an electro-chemical sensor cell, it is possible to detect an electromotive force that corresponds to a difference between the amount of oxygen generated through reduction of an NO_{X} component in the atmosphere around the measurement electrode 44 and the amount of oxygen contained in reference air. With this configuration as well, it is also possible to obtain the concentration of the nitrogen oxide component in the measurement target gas.

Furthermore, the second solid electrolyte layer 6, the spacer layer 5, the first solid electrolyte layer 4, the third substrate layer 3, the external pump electrode 23, and the reference electrode 42 constitute an electro-chemical sensor cell 83. The gas sensor element 100 is configured to be capable of detecting the oxygen partial pressure in the measurement target gas outside the sensor, based on an electromotive force Vref obtained by the sensor cell 83.

In the gas sensor element 100 with this configuration, when the main pump cell 21 and the auxiliary pump cell 50 operate, the measurement target gas whose oxygen partial pressure is always kept at a constant low value (a value that does not substantially affect the NOₓ measurement) can be supplied to the measurement pump cell 41. Accordingly, the gas sensor element 100 is configured to be capable of specifying the concentration of nitrogen oxide in the measurement target gas, based on the pump current Ip2 that flows when oxygen generated through reduction of NOₓ is pumped out by the measurement pump cell 41 substantially in proportion to the concentration of nitrogen oxide in the measurement target gas.

Furthermore, in order to improve the oxygen ion conductivity of the solid electrolyte, the gas sensor element 100 includes a heater 70 that serves to adjust the temperature of the gas sensor element 100 through heating and heat retention. In the example in FIG. 1, the heater 70 includes a heater electrode 71, a heat generating unit 72, a lead unit 73, a heater insulating layer 74, and a pressure dispersing hole 75. The lead unit 73 may be constituted by a through-hole.

In this embodiment, the heater 70 is arranged at a position that is closer to the lower face of the gas sensor element 100 than to the upper face of the gas sensor element 100 in the thickness direction (vertical direction/stack direction) of the gas sensor element 100. Note that the arrangement of the heater 70 is not limited to such an example, and may be selected as appropriate according to the embodiment.

The heater electrode 71 is an electrode formed so as to be in contact with the lower face of the first substrate layer 1 (the lower face of the gas sensor element 100). When the heater electrode 71 is connected to an external power source, electricity can be supplied from the outside to the heater 70.

The heat generating unit 72 is an electrical resistor formed so as to be held between the second substrate layer 2 and the third substrate layer 3 from above and below. The heat generating unit 72 is connected via the lead unit 73 to the heater electrode 71, and, when electricity is supplied from the outside via the heater electrode 71, the heater 72 generates heat, thereby heating and keeping the temperature of a solid electrolyte constituting the gas sensor element 100.

Furthermore, the heater 72 is embedded over the entire region from the first internal cavity 15 to the second internal cavity 17, and thus the entire gas sensor element 100 can be adjusted to a temperature at which the above-described solid electrolyte is activated.

The heater insulating layer 74 is an insulating layer constituted by an insulating member made of alumina or the like on the upper and lower faces of the heat generating unit 72. The heater insulating layer 74 is formed in order to ensure the electrical insulation between the second substrate layer 2 and the heat generating unit 72 and between the third substrate layer 3 and the heat generating unit 72.

The pressure dispersing hole 75 is a hole that extends through the third substrate layer 3 and is connected to the reference gas introduction space 43, and is formed in order to alleviate an increase in the internal pressure in accordance with an increase in the temperature in the heater insulating layer 74.

According to an example of the manufacturing method, for example, processes such as predetermined processing and wiring pattern printing are performed on ceramic green sheets corresponding to the respective layers. After the processes are performed, the sheets are stacked and integrated through firing. Accordingly, the gas sensor element 100 can be manufactured.

### Lead Structure

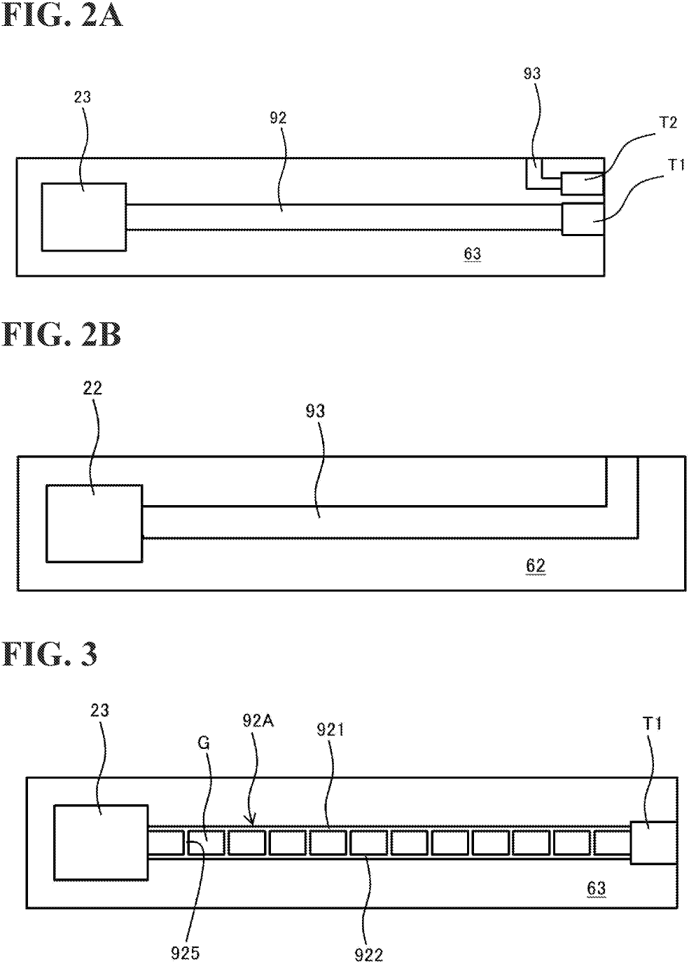

FIGS. 2A and 2B are schematic views schematically showing an example of the lead structure of the main pump cell 21. FIG. 2A schematically shows an example of the lead 92 connected to the external pump electrode 23, and FIG. 2B schematically shows an example of the lead 93 connected to the internal pump electrode 22.

In the example in FIG. 2B, the lead 93 is provided on the lower face 62 of the second solid electrolyte layer 6. The lower face 62 of the second solid electrolyte layer 6 is an example of the first face adjacent to the internal space. Furthermore, the internal pump electrode 22 provided on the lower face 62 is an example of the first pump electrode.

In this embodiment, the internal pump electrode 22 has a structure in the form of a tunnel, and thus the face on which the lead 93 is provided does not have to be limited to the lower face 62 of the second solid electrolyte layer 6. In another example, the lead 93 may be provided on any one face out of the upper face of the first solid electrolyte layer 4 and the side faces of the spacer layer 5. In this case, the face on which the lead 93 is provided is an example of the first face.

In the example in FIG. 2B, the internal pump electrode 22 (the ceiling electrode portion 22a) is formed in the shape of a rectangle. Note that the shape of the internal pump electrode 22 is not limited to such an example, and may be selected as appropriate according to the embodiment.

The lead 93 extends from the internal pump electrode 22 (the ceiling electrode portion 22a) toward a terminal T2. The terminal T2 may be arranged as appropriate according to the embodiment. In the example in FIGS. 2A and 2B, the terminal T2 is arranged on the rear end side of the upper face 63 (the right end in the drawings). The lead 93 extends from the internal pump electrode 22 (the ceiling electrode portion 22a) arranged on the lower face 62 toward the rear end, and extends at the rear end from the lower face 62 to the upper face 63 to reach the terminal T2. The lead 93 is an example of the first lead.

Meanwhile, in the example in FIG. 2A, the lead 92 is provided on the upper face 63 of the second solid electrolyte layer 6. The upper face 63 of the second solid electrolyte layer 6 is an example of the second face adjacent to an external space. Furthermore, the external pump electrode 23 provided on the upper face 63 is an example of the second pump electrode.

In the example in FIG. 2A, the external pump electrode 23 is formed in the shape of a rectangle. Note that the shape of the external pump electrode 23 is not limited to such an example, and may be selected as appropriate according to the embodiment.

The lead 92 extends from the external pump electrode 23 toward a terminal T1. The terminal T1 may be arranged as appropriate according to the embodiment. In the example in FIG. 2A, the terminal T1 is arranged on the rear end side of the upper face 63 (the right end in the drawings). The terminal T1 is configured to be electrically connected to the terminal T2. Accordingly, the lead 92 is configured to be electrically connected to the lead 93. The lead 92 is an example of the second lead.

The shape of the leads (92 and 93) may be selected as appropriate according to the embodiment. In the example in FIGS. 2A and 2B, the leads (92 and 93) are each formed in the shape of a straight line. The faces (62 and 63) may be coated with an insulating material (not shown), and the leads (92 and 93) may be formed on the insulating material. Precious metals such as platinum are used as materials for the leads (92 and 93).

In this embodiment, at least one of the leads 92 and 93 has a shape with a maximum current density of 3.5 A/mm² or less. The at least one of the leads 92 and 93 may be the lead with a higher resistance out of the leads 92 and 93.

From the viewpoint of suppressing a deterioration in the measurement precision, at least one of the leads 92 and 93 may have a maximum current density of 3.4, 3.3, 3.2, 3.1, 3.0, 2.9, 2.8, 2.7, 2.6, 2.5, 2.4, 2.3, 2.2, 2.1, 2.0, 1.9, 1.8, 1.7, 1.6, 1.5, 1.4, 1.3, 1.2, 1.1, or 1.0 A/mm² or less. Furthermore, at least one of the leads 92 and 93 may have a maximum current density of 0.05 A/mm² or more.

As an example of the dimensions, at least one of the leads 92 and 93 may have a length of 20 to 60 mm and a cross-sectional area of 0.001 to 0.01 mm² so as to have a maximum current density that falls within the above-described range.

Furthermore, as an example of the method for calculating the maximum current density, the maximum current density of a lead may be calculated by measuring current flowing through a measurement target gas with an oxygen concentration of 20.5% at a portion of the lead with the smallest cross-sectional area and dividing the measured current by the cross-sectional area.

In an example, at least either the auxiliary pump cell 50 or the measurement pump cell 41 may also have a lead structure similar to that of the main pump cell 21.

If the auxiliary pump cell 50 has a lead structure similar to that of the main pump cell 21, the auxiliary pump electrode 51 is an example of the first pump electrode, and the external pump electrode 23 is an example of the second pump electrode. The lead extending from the auxiliary pump electrode 51 may be provided on any face among the lower face 62 of the second solid electrolyte layer 6, the upper face of the first solid electrolyte layer 4, and the side faces of the spacer layer 5 on which the auxiliary pump electrode 51 is arranged, and the face on which the lead is provided is an example of the first face. The lead extending from the auxiliary pump electrode 51 is an example of the first lead. The lead extending from the external pump electrode 23 is an example of the second lead. The other aspects of the lead structure of the auxiliary pump cell 50 may be similar to those of the lead structure of the main pump cell 21.

If the measurement pump cell 41 has a lead structure similar to that of the main pump cell 21, the measurement electrode 44 is an example of the first pump electrode, and the external pump electrode 23 is an example of the second pump electrode. The upper face of the first solid electrolyte layer 4 on which the measurement electrode 44 is arranged is an example of the first face. The lead extending from the measurement electrode 44 is an example of the first lead. The lead extending from the external pump electrode 23 is an example of the second lead. The other aspects of the lead structure of the measurement pump cell 41 may be similar to those of the lead structure of the main pump cell 21.

In another example, the auxiliary pump cell 50 and the measurement pump cell 41 may have a lead structure different from that of the main pump cell 21.

### Characteristics

As described above, in the main pump cell 21 of the gas sensor element 100 according to this embodiment, at least one of the leads 92 and 93 is set to have a maximum current density of 3.5 A/mm² or less. According to the above-mentioned relational expression, a larger cross-sectional area results in a smaller (maximum) current density, and a smaller cross-sectional area results in a larger (maximum) current density. Through the examples described below, it was found that, if the maximum current density is 3.5 A/mm² or less, it is possible to suppress a deterioration in the measurement precision. Thus, according to this embodiment, it is possible to suppress a deterioration in the measurement precision caused by an operation of the main pump cell 21, while also reducing the manufacturing cost of the gas sensor element 100, by reducing the cross-sectional area of at least one of the leads 92 and 93 based on the maximum current density. It is possible to further suppress a deterioration in the measurement precision, by adopting a lead structure similar to that of the main pump cell 21 for at least either the auxiliary pump cell 50 or the measurement pump cell 41.

Furthermore, in this embodiment, the at least one of the leads 92 and 93 may be the lead with a higher resistance out of the leads 92 and 93. As described above, a higher resistance is likely to cause a deterioration in the measurement precision. According to this embodiment, it is possible to appropriately suppress a deterioration in the measurement precision while also reducing the manufacturing cost of the gas sensor element 100, by setting the maximum current density of the lead with a higher resistance to 3.5 A/mm² or less.

### Modified Examples

Although an embodiment of the present invention has been described above, the above description of the embodiment is merely an example of the invention in all aspects. It will be appreciated that various improvement and modifications can be made in the embodiment. Constituent elements may be omitted from, replaced by, and added to the constituent elements of the embodiment as appropriate. Also, the shape and size of each constituent element of the embodiment may be changed as appropriate according to the embodiment. For example, the following changes are possible. Note that constituent elements similar to those in the foregoing embodiment are denoted by the same reference numerals, and a description of aspects similar to those in the foregoing embodiment has been omitted as appropriate. The following modified examples may be combined as appropriate.

### (I) Application Target of Lead Structure

In the description above, an example of the case was described in which the lead structure according to the embodiment of the present invention is applied to the main pump cell 21. However, the application target of the above-described lead structure does not have to be limited to the main pump cell 21. As described above, at least either the auxiliary pump cell 50 or the measurement pump cell 41 may have the above-described lead structure. In a similar manner, at least one of the cells 80 to 83 related to the reference electrode 42 may have the above-described lead structure. If at least one of the cells has the above-described lead structure, the main pump cell 21 may have a lead structure different from that in the foregoing embodiment.

### (II) Shape of Leads

In the foregoing embodiment, the lead 92, which is an example of the second lead, and the lead 93, which is an example of the first lead, are both formed in the shape of a straight line. However, the shape of the first and second leads does not have to be limited to such an example. In another example, at least one of the first and second leads may include a plurality of columns each extending in a first direction, and a plurality of connecting portions each extending in a second direction that intersects the first direction and each being connected to two adjacent columns out of the plurality of columns. A gap may be provided between two connecting portions that are adjacent to each other in the first direction out of the plurality of connecting portions.

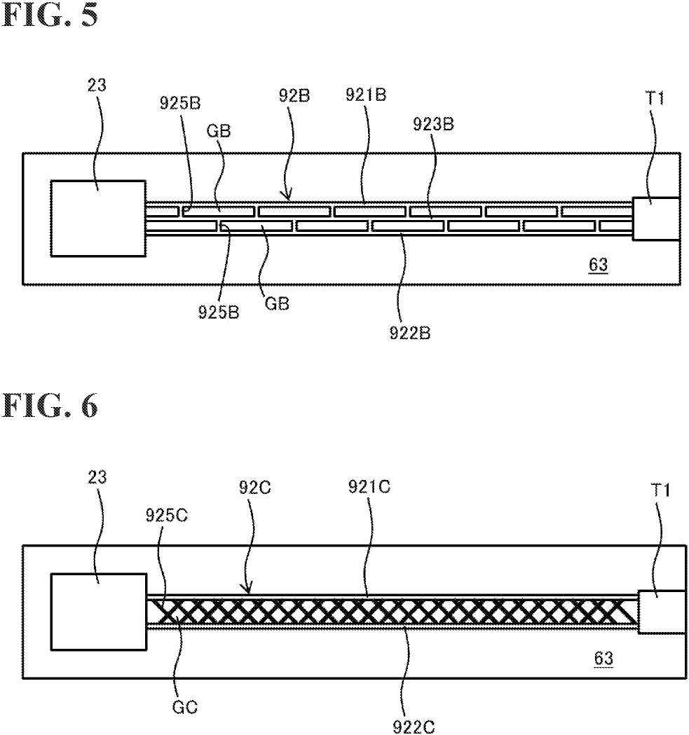

FIG. 3 is a schematic view schematically showing an example of the case in which the configuration according to this modified example is applied to a lead 92A extending from the external pump electrode 23. In the example in FIG. 3, the lead 92A includes two columns (921 and 922) and eleven connecting portions 925. In FIG. 3, the configuration related to the lead 93 extending from the internal pump electrode 22 in FIG. 2A is not shown. In FIGS. 5 to 7, which will be described, as well, the configuration related to the lead 93 is not shown.

The left-right direction in FIG. 3 (the longitudinal direction of the gas sensor element) is an example of the first direction, and the upper-lower direction in FIG. 3 (the width direction of the gas sensor element) is an example of the second direction. In the example in FIG. 3, the angle at which the first direction and the second direction intersect each other is a right angle, but does not have to be limited to such an example. The first direction and the second direction may intersect each other at an acute angle or an obtuse angle.

Each connecting portion 925 extends in the second direction, and its end portions are connected to two columns (921 and 922) that are adjacent to each other in the second direction. A gap G is provided between two connecting portions 925 that are adjacent to each other in the first direction. Accordingly, the lead 92A is formed in the form of a ladder.

The shape of the connecting portions 925 may be selected as appropriate according to the embodiment. In an example, each connecting portion 925 may have a constant width (length in the direction perpendicular to the second direction). In another example, each connecting portion 925 may be formed such that the center portion has a width larger than that of the end portions. Note that, when current flows through the lead, stress is likely to occur at the end portions of each connecting portion (i.e., portions of each connecting portion connected to the columns), and this stress tends to cause damage at the end portions of the connecting portion. Thus, in another example, each of the connecting portions may have two end portions that are respectively connected to two adjacent columns, and a center portion that is at a distance from the two end portions. At least one of the two end portions of the connecting portion may have a width larger than that of the center portion.

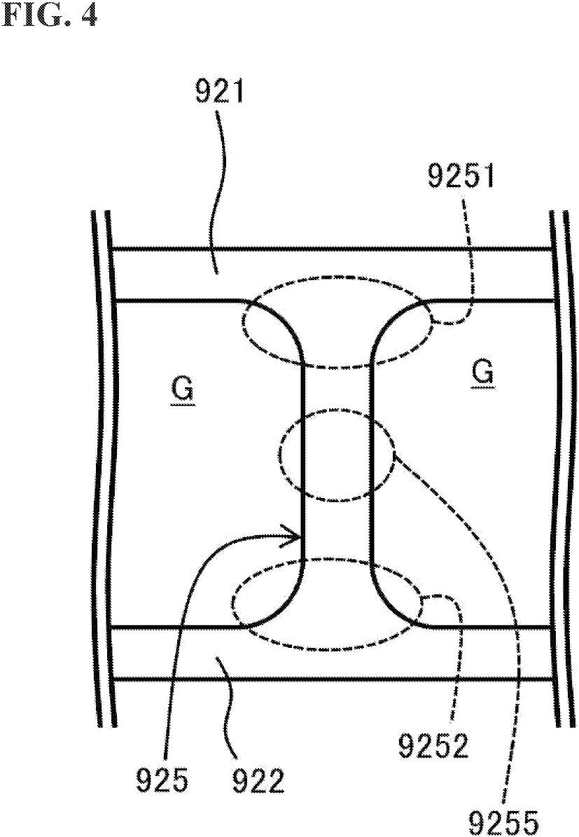

FIG. 4 is an enlarged schematic view schematically showing an example of the case in which the configuration of this connecting portion is applied to the lead 92A. In the example in FIG. 4, each connecting portion 925 has two end portions (9251 and 9252) that are respectively connected to two adjacent columns (921 and 922), and a center portion 9255 that is at a distance from the two end portions (9251 and 9252). At least one of the two end portions (9251 and 9252) of the connecting portion 925 has a width larger than that of the center portion 9255.

In the example in FIG. 4, both of the two end portions (9251 and 9252) have a width larger than that of the center portion 9255. It is preferable that both end portions have a width larger than that of the center portion in this manner. Note that the configuration of this connecting portion does not have to be limited to such an example. In another example, at least one of the two end portions (9251 and 9252) may have a width that is the same as or smaller than that of the center portion 9255.

According to this configuration, an end portion (9251, 9252) of each connecting portion 925 has a width larger than that of the center portion 9255, and thus a breakage at the end portion (9251, 9252) can be suppressed. As a result, it is possible to improve the durability of the lead 92A. The other aspects of the configuration of the lead 92A may be similar to those of the lead 92 according to the foregoing embodiment.

### Number of Columns

In an example of the configuration of the lead according to the above-described modified example, the number of columns is two. However, the number of columns does not have to be limited to such an example, and may be three or more.

FIG. 5 is a schematic view schematically showing an example of a lead 92B according to this modified example. The lead 92B extends from the external pump electrode 23 toward the terminal T1, as with the lead 92A. In the example in FIG. 5, the lead 92B includes three columns (921B, 922B, and 923B) and twelve connecting portions 925B.

Each connecting portion 925B is connected to two adjacent columns (921B and 923B or 923B and 922B). A gap GB is provided between two connecting portions 925B that are adjacent to each other in the first direction.

The shape of the connecting portions 925B may be selected as appropriate according to the embodiment. In an example, each connecting portion 925B may have a constant width. In another example, each connecting portion 925B may be formed such that the center portion has a width larger than that of the end portions. In another example, each connecting portion 925B may have a configuration similar to that of the connecting portions 925 given as an example in FIG. 4. The other aspects of the configuration of the lead 92B may be similar to those of the lead 92 according to the foregoing embodiment.

### Extending Directions of Connecting Portions

In an example of the configuration of the lead according to the above-described modified example, the connecting portions (925 and 925B) extend in one direction. However, the extending directions of the connecting portions do not have to be limited to one direction. At least one of the plurality of connecting portions may extend in a direction different from that of the other connecting portions.

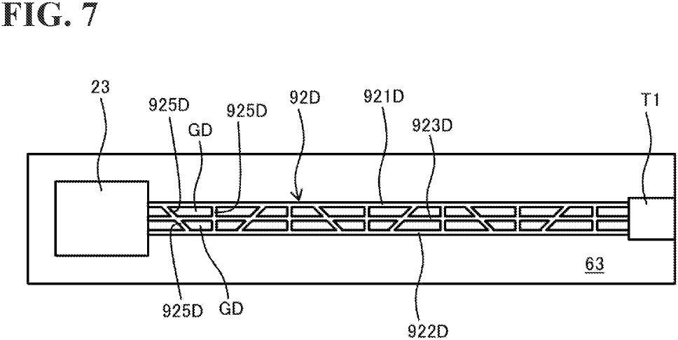

FIG. 6 is a schematic view schematically showing an example of a lead 92C according to this modified example. In the example in FIG. 6, the lead 92C extends from the external pump electrode 23 toward the terminal T1, as with the lead 92A, and includes two columns (921C and 922C). Moreover, the lead 92C includes a plurality of connecting portions 925C.

Some of the plurality of connecting portions 925C extend in a direction that is inclined at an acute angle with respect to the first direction, and are each connected to the two adjacent columns (921C and 922C). The others of the plurality of connecting portions 925C extend in a direction that is inclined at an obtuse angle with respect to the first direction, and are each connected to the two adjacent columns (921C and 922C). These directions are an example of the second direction.

In the example in FIG. 6, the connecting portions 925C extending in a direction that is inclined at an acute angle and the connecting portions 925C extending in a direction that is inclined at an obtuse angle intersect each other. A gap GC is provided between two connecting portions 925C that are adjacent in the first direction and intersect each other. Accordingly, the lead 92C is formed in the form of a mesh.

In this manner, it is also possible that two or more connecting portions extend in different directions and thus partially intersect each other. Note that the configuration of the lead does not have to be limited to such an example. In the case in which the plurality of connecting portions extend in different directions, the connecting portion may be arranged so as not to intersect each other.

The shape of the connecting portions 925C may be selected as appropriate according to the embodiment. In an example, each connecting portion 925C may have a constant width. In another example, each connecting portion 925C may be formed such that the center portion has a width larger than that of the end portions. In another example, each connecting portion 925C may have a configuration similar to that of the connecting portions 925 given as an example in FIG. 4. The other aspects of the configuration of the lead 92C may be similar to those of the lead 92 according to the foregoing embodiment.

### Arrangement of Connecting Portions

In an example of the configuration of the lead according to the above-described modified examples, the connecting portions (925, 925B, and 925C) are independently at a distance from each other. However, the arrangement of the connecting portions does not have to be limited to such an example. At least two or more of the plurality of connecting portions may be formed in one piece.

FIG. 7 is a schematic view schematically showing an example of a lead 92D according to this modified example. In the example in FIG. 7, the lead 92D extends from the external pump electrode 23 toward the terminal T1, as with the lead 92B, and includes three columns (921D, 922D, and 923D). Moreover, the lead 92D includes a plurality of connecting portions 925D.

First connecting portions of the plurality of connecting portions 925D extend in a direction that is inclined at an acute angle with respect to the first direction, and are each connected to two adjacent columns (921D and 923D or 923D and 922D). Second connecting portions of the plurality of connecting portions 925D extend in a direction that is perpendicular to the first direction, and are each connected to two adjacent columns (921D and 923D or 923D and 922D). Third connecting portions of the plurality of connecting portions 925D extend in a direction that is inclined at an obtuse angle with respect to the first direction, and are each connected to two adjacent columns (921D and 923D or 923D and 922D). The extending directions of the connecting portions are an example of the second direction. A gap GD is provided between two connecting portions 925D that are adjacent to each other in the first direction.

In the example in FIG. 7, in the second directions, the connecting portions connecting the two columns (921D and 923D) and the connecting portions connecting the two columns (923D and 922D) are formed in one piece. In this manner, at least two or more of the plurality of connecting portions may be formed in one piece. In other words, the connecting portions may be arranged such that the two or more connecting portions formed in one piece are regarded as one connecting portion and used to connect three or more columns.

The shape of the connecting portions 925D may be selected as appropriate according to the embodiment. In an example, each connecting portion 925D may have a constant width. In another example, each connecting portion 925D may be formed such that the center portion has a width larger than that of the end portions. In another example, each connecting portion 925D may have a configuration similar to that of the connecting portions 925 given as an example in FIG. 4. The other aspects of the configuration of the lead 92D may be similar to those of the lead 92 according to the foregoing embodiment.

### Characteristics

According to these modified examples, compared with the case of a solid structure, the amount of material used for the leads (92A, 92B, 92C, and 92D) can be suppressed by the size of the gaps (G, GB, GC, and GD), and thus it is possible to reduce the manufacturing cost of the gas sensor.

In the above-described modified examples, an example of the case was described in which the configurations are applied to the lead extending from the external pump electrode 23. However, the application target of configurations does not have to be limited to such an example. The configurations of the leads (92A, 92B, 92C, and 92D) according to the modified examples may be also applied to the lead 93 extending from the internal pump electrode 22. If the configurations according to the modified examples are applied to the lead 93, configurations other than that in the modified examples such as those in the foregoing embodiment may be applied to the lead extending from the external pump electrode 23. Different configurations among the configurations of the leads (92A, 92B, 92C, and 92D) according to the modified examples and the configurations according to the embodiment may be applied to the first and second leads. A similar lead structure may be applied also to at least one cell among the auxiliary pump cell 50, the measurement pump cell 41, and the cells 80 to 83 related to the reference electrode 42.

### (III) Others

In the foregoing embodiment, the stack of the gas sensor element 100 is constituted by six solid electrolyte layers. However, the number of solid electrolyte layers constituting the stack is not limited to such an example, and may be selected as appropriate according to the embodiment.

Furthermore, in the foregoing embodiment, the internal space into which the measurement target gas is introduced is provided at the position that is defined by the first solid electrolyte layer 4, the spacer layer 5, and the second solid electrolyte layer 6. However, the arrangement of the internal space is not limited to such an example, and may be selected as appropriate according to the embodiment. The arrangements of the first face, the second face, the first pump electrode, the second pump electrode, the first lead, and the second lead may be selected as appropriate according to the configuration of the stack and the internal space.

Furthermore, in the foregoing embodiment, the internal space has a three-cavity structure. However, the configuration of the internal space is not limited to such an example, and may be selected as appropriate according to the embodiment. In another example, the fourth diffusion control unit 18 and the third internal cavity 19 may be omitted, that is, the internal space may have a two-cavity structure. In this case, the measurement electrode 44 may be provided at a distance from the third diffusion control unit 16, on the upper face of the first solid electrolyte layer 4 adjacent to the second internal cavity 17.

Furthermore, in FIG. 1, the internal pump electrode 22, which is an example of the first pump electrode, and the external pump electrode 23, which is an example of the second pump electrode, are both exposed to a space. However, the state of being adjacent to a space does not have to be limited to such a configuration, and may be a state of being indirectly adjacent to a space via a coating or the like. As another example, the external pump electrode 23 may be covered by a protective member or the like.

Furthermore, in the foregoing embodiment, the reference gas introduction space 43 is provided. However, the configuration of the gas sensor element 100 does not have to be limited to such an example. In another example, the first solid electrolyte layer 4 may extend to the rear end of the gas sensor element 100, and the reference gas introduction space 43 may be omitted. In this case, the air introduction layer 48 may extend to the rear end of the gas sensor element 100.

Furthermore, in the foregoing embodiment, the gas sensor element 100 is configured to measure the concentration of nitrogen oxide (NOₓ). However, the gas sensor element of the present invention does not have to be limited to such a gas sensor element configured to measure the concentration of NOₓ. In another example, the gas sensor element of the present invention may be, for example, other gas sensor elements such as a gas sensor element configured to measure the concentration of oxygen. For example, it is possible to manufacture a gas sensor element for measuring the concentration of oxygen, by omitting the auxiliary pump cell and the measurement pump cell from the gas sensor element 100 according to the embodiment, and arranging the reference electrode under the main pump electrode. In this case, the gas sensor element can measure the concentration of oxygen in the measurement target gas by pumping out oxygen using the main pump cell.

### Examples

In order to verify effects of the present invention, gas sensor elements according to the following examples and comparative examples were fabricated. However, the present invention is not limited to the following examples.

A gas sensor element according to a first example (type: NOₓ sensor) was fabricated by adopting the configuration shown in FIG. 1 above for the configuration of the gas sensor element and adopting the structure shown in FIGS. 2A and 2B for the lead structure of the main pump cell. One of the two leads of the gas sensor element according to the first example had a maximum current density of 0.67 A/mm².

Gas sensor elements according to second to fifth examples were fabricated by changing the cross-sectional areas of the leads of the gas sensor element according to the first example. One of the two leads of the gas sensor element according to the second example had a maximum current density of 0.83 A/mm². One of the two leads of the gas sensor element according to the third example had a maximum current density of 0.89 A/mm². One of the two leads of the gas sensor element according to the fourth example had a maximum current density of 0.18 A/mm². One of the two leads of the gas sensor element according to the fifth example had a maximum current density of 1.14 A/mm².

A gas sensor element according to a sixth example (type: O₂ sensor) was fabricated by omitting the auxiliary pump cell and the measurement pump cell from the gas sensor element according to the first example, and arranging the reference electrode under the main pump electrode. The structure shown in FIG. 3 was adopted for the lead structure of the main pump cell of the gas sensor element according to the sixth example. One of the two leads of the gas sensor element according to the sixth example had a maximum current density of 1.59 A/mm².

A gas sensor element according to a seventh example was fabricated by changing the lead structure of the gas sensor element according to the sixth example to the structure shown in FIG. 5. One of the two leads of the gas sensor element according to the seventh example had a maximum current density of 0.40 A/mm². A gas sensor element according to an eighth example was fabricated by changing the cross-sectional areas of the leads of the gas sensor element according to the sixth example. One of the two leads of the gas sensor element according to the eighth example had a maximum current density of 3.06 A/mm².

On the other hand, a gas sensor element according to a first comparative example was fabricated by changing the cross-sectional areas of the leads of the gas sensor element according to the first example. One of the two leads of the gas sensor element according to the first comparative example had a maximum current density of 6.00 A/mm². Furthermore, a gas sensor element according to a second comparative example was fabricated by changing the cross-sectional areas of the leads of the gas sensor element according to the sixth example. One of the two leads of the gas sensor element according to the second comparative example had a maximum current density of 4.29 A/mm².

Next, the gas sensor elements according to the examples and the comparative examples were evaluated in terms of the rate of change in oxygen sensitivity and the dependency on oxygen concentration, by measuring the concentration of oxygen contained in a measurement target gas using the gas sensor elements.

Specifically, five model gases in total were prepared, namely four model gases with oxygen concentrations of 0%, 5%, 10%, and 18% (NO concentration was constant at 500 ppm) and one model gas with an NO concentration of 0 ppm and an oxygen concentration of 20.5%. The O₂ current Ip0 and the NOₓ current Ip2 of each of these five model gases (all of which had a residual of N₂) were measured using the gas sensor elements according to the examples and the comparative examples, before the start of an accelerated durability test, 1000 hours after the start, 2000 hours after the start, and at the end of the test (3000 hours after the start). In all cases, the element drive temperature was 850° C. In the accelerated durability test, the gas sensor elements were attached to the exhaust pipe of a diesel engine and exposed to exhaust gas for 3000 hours.

Values obtained by dividing, by an oxygen concentration (20.5%) at an NO concentration of 0 ppm, the measured value of O₂ current Ip0 at that concentration at the respective time points mentioned above were calculated as the slope of the sensitivity characteristic (the rate of change in O₂ current with respect to the oxygen concentration value). The slope of the sensitivity characteristic before the start of the accelerated durability test was used as a reference (initial value) to calculate the rate of change in oxygen sensitivity, which is the rate of change in the slope at each elapsed time. The degrees of change in the oxygen sensitivity of the gas sensor elements according to the examples and the comparative examples were determined based on the calculated values (first determination).

Then, coefficients of determination R² of the NOₓ sensor-type gas sensor elements (the first to fifth examples and the first comparative example) were calculated as indexes of the dependency of the measured currents (Ip2) on oxygen concentration from the results of measurements on the model gases. The degrees of linearity of the measured currents with respect to the oxygen concentration were then determined based on the calculated coefficients of determination R² (second determination).

TABLE 1

| | Type | Maximum current density through lead [A/mm²] | Lead structure | First determination | Second determination |
|---|---|---|---|---|---|
| Ex. 1 | NOₓ sensor | 0.67 | Straight | A | A |
| Ex. 2 | NOₓ sensor | 0.83 | Straight | A | A |
| Ex. 3 | NOₓ sensor | 0.89 | Straight | A | A |
| Ex. 4 | NOₓ sensor | 0.18 | Straight | A | A |
| Ex. 5 | NOₓ sensor | 1.14 | Straight | B | B |
| Ex. 6 | O₂ sensor | 1.59 | Ladder (FIG. 3 ) | A | - |
| Ex. 7 | O₂ sensor | 0.40 | Ladder (FIG. 5 ) | A | - |
| Ex. 8 | O₂ sensor | 3.06 | Ladder (FIG. 3 ) | B | - |
| Com.Ex. 1 | NOₓ sensor | 6.00 | Straight | C | C |
| Com.Ex. 2 | O₂ sensor | 4.29 | Ladder | C | - |

Table 1 shows the evaluation results of the first and second determinations. In the first determination, if the absolute value of the rate of change in oxygen sensitivity is 10% or less, it is evaluated as “A: The change in oxygen sensitivity is suitably suppressed”. If the absolute value of the rate of change in oxygen sensitivity is more than 10% and 20% or less, it is evaluated as “B: The change in oxygen sensitivity is suppressed within the range acceptable for actual use”. If the absolute value of the rate of change in oxygen sensitivity is more than 20%, it is evaluated as “C: The oxygen sensitivity changes beyond the acceptable range”.

Meanwhile, in the second determination, if the value of the coefficient of determination R² is 0.975 or more, it is evaluated as “A: The linearity of the measured current with respect to the oxygen concentration is satisfactorily maintained”. If the value of the coefficient of determination R² is 0.950 or more and less than 0.975, it is evaluated as “B: The linearity of the measured current with respect to the oxygen concentration is maintained within the range acceptable for actual use”. If the value of the coefficient of determination R² is less than 0.950, it is evaluated as “C: The linearity of the measured current with respect to the oxygen concentration is significantly impaired”.

The first to fourth examples were evaluated as “A” in both of the first and second determinations. The fifth example was evaluated as “B” in both of the first and second determinations. The sixth and seventh examples were evaluated as “A” in the first determination, and the eighth example was evaluated as “B” in the first determination. On the other hand, the first comparative example was evaluated as “C” in both of the first and second determinations. The second comparative example was evaluated as “C” in the first determination.

It was inferred from these results that it is possible to suppress a deterioration in the measurement precision of a gas sensor element by forming at least one of the two leads such that the maximum current density is 3.5 A/mm² or less, which is a value between the eighth example and the second comparative example. Furthermore, it was found that it is possible to suitably suppress a deterioration in the measurement precision of a gas sensor element by forming at least one of the two leads such that the maximum current density is 3.1 A/mm² or less (which is a value that matches the examples). Thus, it was found that it is possible to suppress a deterioration in the measurement precision while also reducing the manufacturing cost of a gas sensor element, by reducing the cross-sectional areas of the leads based on these maximum current densities.

### List of Reference Numerals

100 Gas sensor element
22 Internal pump electrode
23 External pump electrode
62 Lower face
63 Upper face
92, 93 Lead
T Terminal
921, 922 Column
925 Connecting portion
9251, 9252 End portion
9255 Center portion
G Gap

What is claimed is:

1. A gas sensor element comprising:
a stack formed by stacking a plurality of oxygen ion-conductive solid electrolyte layers, and including an internal space configured to receive a measurement target gas from the outside, a first face adjacent to the internal space, and a second face adjacent to an external space;
a first pump electrode provided on the first face;
a second pump electrode provided on the second face;
a first lead formed on the first face so as to extend from the first pump electrode; and
a second lead formed on the second face so as to extend from the second pump electrode and configured to be electrically connected to the first lead,
wherein at least one of the first and second leads has a shape with a maximum current density of 3.5 A/mm² or less.

2. The gas sensor element according to claim 1, wherein the at least one of the first and second leads is a lead with a higher resistance out of the first and second leads.

3. The gas sensor element according to claim 1,
wherein at least one of the first and second leads includes:
a plurality of columns each extending in a first direction; and
a plurality of connecting portions each extending in a second direction that intersects the first direction and each being connected to two adjacent columns out of the plurality of columns, and
a gap is provided between two connecting portions that are adjacent to each other in the first direction out of the plurality of connecting portions.

4. The gas sensor element according to claim 3,
wherein each of the connecting portions has two end portions that are respectively connected to two adjacent columns, and a center portion that is at a distance from the two end portions, and
at least one of the two end portions of the connecting portion has a width larger than that of the center portion.

5. The gas sensor element according to claim 1, wherein at least one of the first and second leads has a shape with a maximum current density of 3.1 A/mm² or less.
